(19) United States
(12) Patent Application Publication
(10) Pub. No.: US 2013/0027969 A1
(43) Pub. Date: Jan. 31, 2013

(54) ELECTRONIC DEVICE WITH LIGHT ADJUSTING MEMBER

(71) Applicants: SHUANG-HONG XIAO, Shenzhen City (CN); HE-HUI YANG, Shenzhen City (CN); KAI-KUEI WU, Tu-Cheng (TW); KUN-CHIH HSIEH, Tu-Cheng (TW)

(72) Inventors: SHUANG-HONG XIAO, Shenzhen City (CN); HE-HUI YANG, Shenzhen City (CN); KAI-KUEI WU, Tu-Cheng (TW); KUN-CHIH HSIEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/284,996

(22) Filed: Oct. 31, 2011

(30) Foreign Application Priority Data
Jul. 28, 2011 (CN) 201110213349.X

(51) Int. Cl. F21V 8/00

(52) U.S. Cl. 362/606

(57) ABSTRACT

An electronic device includes a shell, a circuit board, a light source mounted on the circuit board, a light guiding member defining a first pattern, a transparent light adjusting member defining a second pattern, a driving member, a sliding member slidably received in the shell, an optical sensor and a processor. The light adjusting member is revolvably mounted to the shell. The sliding member is mechanically coupled to the light adjusting member. The driving member is configured to drive the sliding member to move linearly so as to enable the sliding member to drive the light adjusting member to revolve, thereby rotation of the second pattern relative to the first pattern causing variation of light intensity passing through the light adjusting member. The optical sensor detects the ambient brightness. The process controls the driving member based on the ambient brightness.

### BACKGROUND

1. Technical Field

The present disclosure relates to electronic devices, especially to an electronic device with a light adjusting member.

2. Description of Related Art

Light emitting diodes (LEDs) are widely used in electronic devices as a backlight to light logos (e.g., a mark, a label, or a brand) thereon. The light of the logo is usually invariable. During an exhibition of the electronic device, if the ambient brightness is strong, the logos cannot be visibly shown, which has a negative influence on the exhibition.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partial, isometric view of an electronic device according to an exemplary embodiment.

FIG. 2 is similar to FIG. 1, but viewed from a different viewpoint and with a circuit board omitted.

FIG. 3 is an exploded view of the electronic device in FIG. 2.

### DETAILED DESCRIPTION

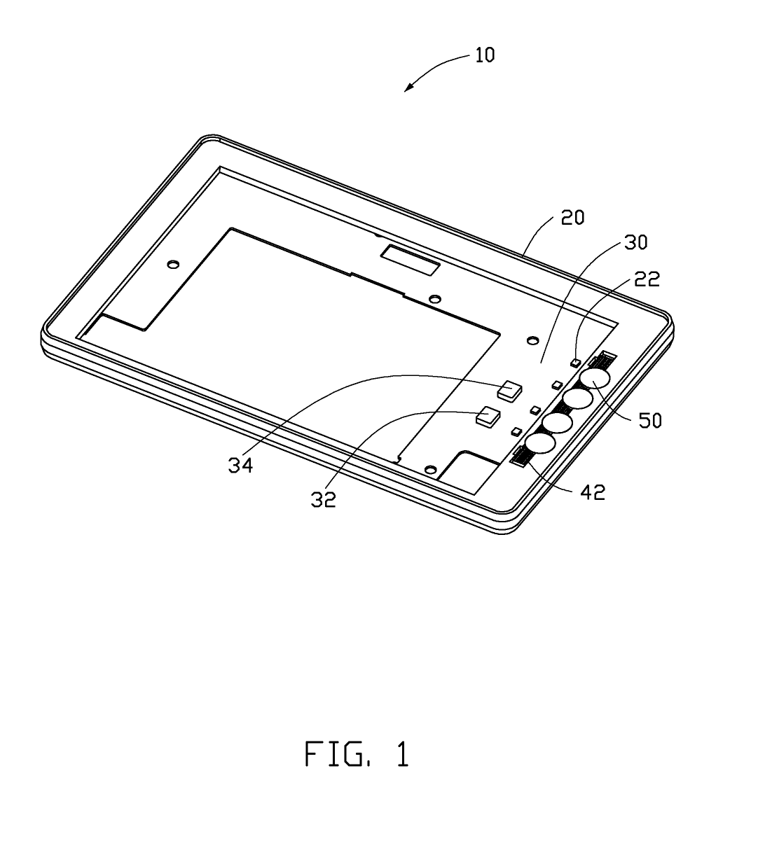

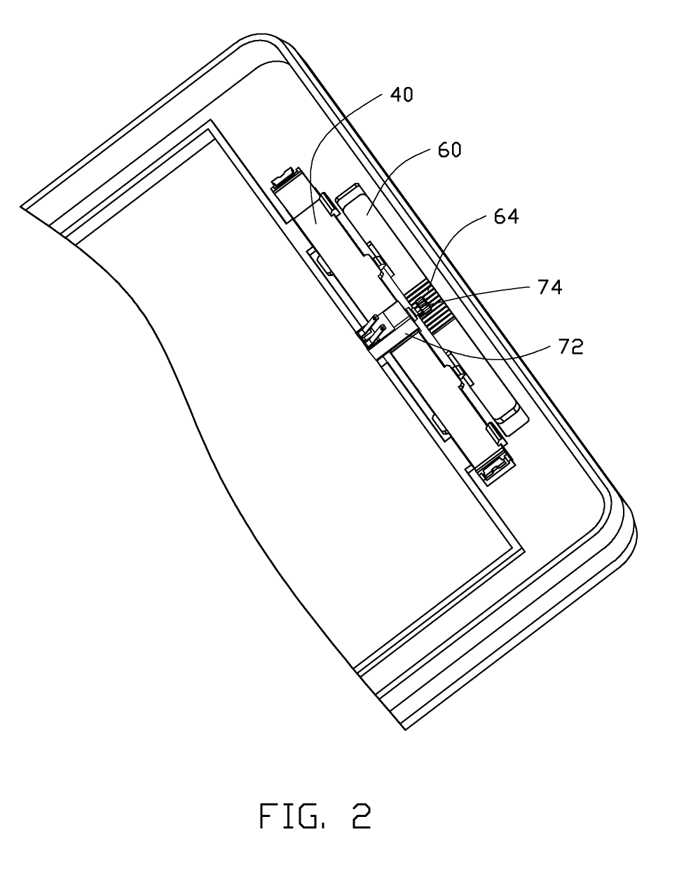

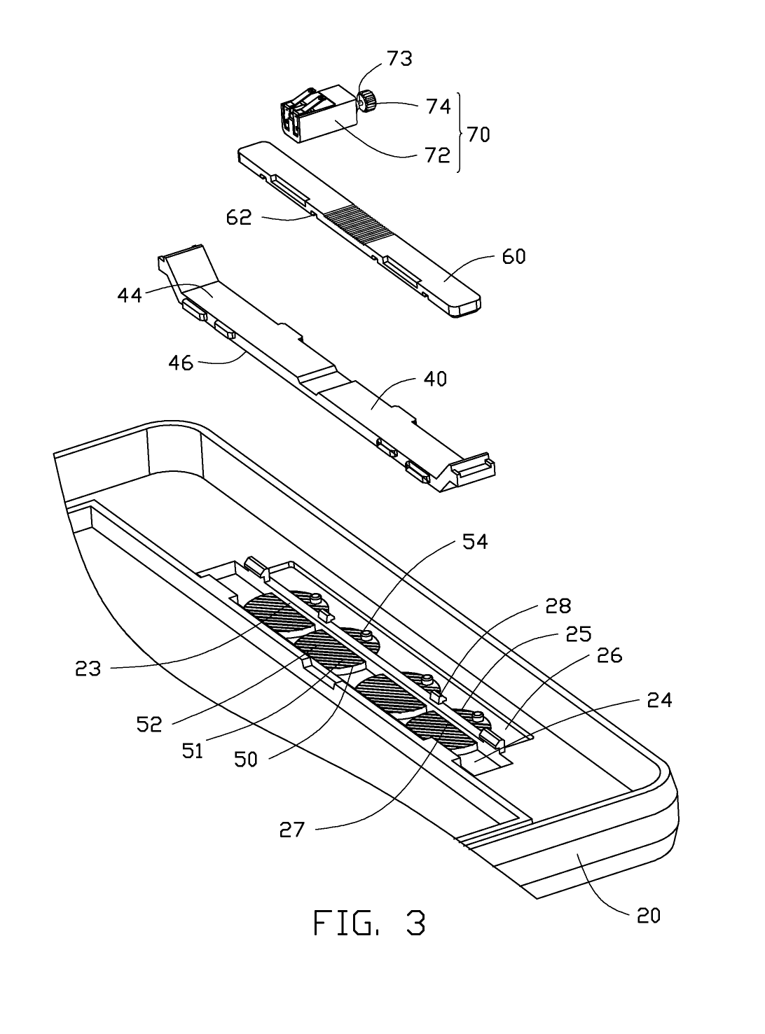

Referring to FIGS. 1 to 3, according to an exemplary embodiment, an electronic device 10 includes a shell 20, a circuit board 30 fixed to the shell 20, a transparent light guiding member 40, a number of transparent light adjusting members 50, a sliding member 60, a driving member 70 and a number of icons (not shown) optically aligned with the light adjusting members 50 and exposed outside the shell 20.

The circuit board 30 includes a number of light sources 22 mounted thereon. The light guiding member 40 is disposed between the circuit board 30 and the transparent light adjusting members 50.

The light guiding member 40 includes a light incident surface 44 facing the light source 22 and a light emitting surface 46 defines a first pattern 42 facing the light adjusting members 50. The light emitted from the light sources 22 pass the light incident surface 44 to the light emitting surface 46 and enter the light adjusting members 50. The first pattern 42 is configured for changing the light exitance of the light passing through the light guiding member 40. In the embodiment, the first pattern 42 is a number of parallel lines.

The light adjusting members 50 are rotatably connected to the shell 20 and spaced from the circuit board 30. Each light adjusting member 50 includes a first surface 51 defining a second pattern 52 opposite the light guiding member 40. The second pattern 52 is configured for changing the light exitance of the light passing through the light adjusting member 50. In the embodiment, the second pattern 52 is a number of parallel lines texture.

The driving member 70 is electrically connected to the circuit board 30. The driving member 70 is configured for driving the sliding member 60 to move linearly so as to enable the sliding member 60 to drive the light adjusting member 50 to revolve, thereby rotation of the second pattern 52 relative to the first pattern 42 causing variation of light intensity passing through the light adjusting member 50, thus adjusting light exitance of the light passing through the light adjusting member 50.

The shell 20 includes an elongated recess 24 and a sliding groove 26 parallel to the recess 24. The length of the recess 24 corresponds to the length of the light guiding member 40. The recess 24 is configured for receiving the light guiding member 40. The sliding groove 26 is configured for receiving the sliding member 60. The length of the sliding member 60 is less than that of the sliding groove 26, thus the sliding member 60 is movable in the sliding groove 26. The shell 20 includes a dividing wall 23 between the recess 24 and the sliding groove 26. The dividing wall 23 includes a number of hooks 28 protruding upward therefrom. The hooks 28 are configured for limiting the light guiding member 40 and the sliding member 60 in the recess 24 and the sliding groove 26. The dividing wall 23 defines a number of openings 27 communicating the recess 24 with the sliding groove 26.

The bottom of the sliding groove 26 is formed with a number of recesses 25. The light adjusting member 50 passes through the opening 27, allowing that a portion of the light adjusting member 50 is received in the elongated recess 24 and the other portion of the light adjusting member 50 is received in the recess 25. Each recess 25 is arc shaped to fit a portion of one light adjusting member 50 therein. Each light adjusting member 50 is received in the recess 25 in a clearance fit, thus the light adjusting member 50 is rotatable.

The sliding member 60 defines a number of indentations 62. Each light adjusting member 50 is round-shaped and includes a protrusion 54 offset from a center thereof. Each protrusion 54 is moveably received in one indentation 62. When the sliding member 60 slides in the sliding groove 26, the protrusion 54s received in the indentations 62 are urged by the sliding member 60, thereby rotating the light adjusting members 50. In the embodiment, the sliding member 60 is formed with a rack 64 with a plurality of teeth at a side opposite the indentation 62.

The driving member 70 includes a motor 72 electrically connected to the circuit board 30 and a gear 74 surrounds an output shaft 73 of the motor 72. The gear 74 engages with the rack 64, thereby driving the sliding member 60 to slide in the sliding groove 26 when the output shaft 73 rotates.

The circuit board 30 further includes an optical sensor 32 and a processor 34. The optical sensor 32 is configured to detect an ambient brightness. The processor 34 is configured to control the motor 72 based on the detected ambient brightness. As a result, the angle between the second pattern 52 of the light adjusting member 50 can be controlled by the processor 34 according to the detected ambient brightness. Thus, the adjusting light exitance of the light passing through the light adjusting member 50 is changeable based on the detected ambient brightness.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic device comprising:
a shell;
a circuit board fixed to the shell;
a light source mounted on the circuit board;
a light guiding member comprising a light incident surface facing the light source and a light emitting surface defining a first pattern therein;
a transparent light adjusting member revolvably mounted to the shell, the light adjusting member comprising a first surface defining a second pattern therein;
a driving member electrically connected to the circuit board;
a sliding member slidably received in the shell, the sliding member mechanically coupled to the light adjusting member, the driving member configured to drive the sliding member to move linearly so as to enable the sliding member to drive the light adjusting member to revolve, thereby rotation of the second pattern relative to the first pattern causing variation of light intensity passing through the light adjusting member;
an icon optically aligned with the light adjusting member and exposed outside the shell;
an optical sensor configured to detect an ambient brightness; and
a processor configured to control the driving member based on the detected ambient brightness.

2. The electronic device of claim 1, wherein the second pattern of the light adjusting member is a plurality of parallel lines.

3. The electronic device of claim 1, wherein the first pattern of the light adjusting member is a plurality of parallel lines.

4. The electronic device of claim 1, wherein the second side surface of the light adjusting member faces the light emitting surface of the light guide member.

5. The electronic device of claim 1, wherein the light adjusting member is round-shaped, and includes a protrusion offset from a center thereof, the protrusion rotatably coupled to the sliding member.

6. The electronic device of claim 5, wherein the sliding member defines an indentation, the protrusion is rotatably received in the indentation.

7. The electronic device of claim 1, wherein the shell defines a recess, and the light adjusting member is rotatably received in the recess.

8. The electronic device of claim 7, wherein the recess is arc shaped to fit a portion of the light adjusting member therein.

9. The electronic device of claim 1, wherein the sliding member includes a rack with a plurality of teeth, the driving member comprises a motor electrically connected to the circuit board and a gear, the motor comprises an output shaft, the gear surrounds the output shaft and engages with the rack.
